(19) United States
(12) Patent Application Publication
(10) Pub. No.: US 2025/0369072 A1
(43) Pub. Date: Dec. 4, 2025

(54) SYSTEM AND METHOD FOR RECYCLING MAGNETIC MATERIAL AND RARE EARTH ELEMENTS CONTAINED THEREIN

(71) Applicant: CYCLIC MATERIALS INC., Toronto (CA)

(72) Inventors: Ahmad GHAHREMAN, Kingston (CA); Alexander FORSTNER, Peterborough (CA); Matthew James HEPBURN, Toronto (CA); Patrick W. NEE, Jr., New York, NY (US)

(21) Appl. No.: 18/874,458

(22) PCT Filed: Jun. 13, 2023
(86) PCT No.: PCT/CA2023/050817

§ 371 Date: Dec. 12, 2024

Related U.S. Application Data
(60) Provisional application No. 63/366,374, filed on Jun. 14, 2022.
(60) Provisional application No. 63/399,474, filed on Aug. 19, 2022.
(60) Provisional application No. 63/399,496, filed on Aug. 19, 2022.

(51) Int. Cl. C22B 59/00; C01F 17/247; C22B 1/248; C22B 3/00; C22B 7/00

(52) U.S. Cl. CPC C22B 59/00; C01F 17/247; C22B 1/248; C22B 7/005; C22B 7/007; C22B 23/0461

(57) ABSTRACT

Methods and systems for the extraction of magnetic material from magnet containing material, and for extraction of rare earth elements (REEs) from the magnetic material are disclosed. An exemplary system includes a milling/washing unit for magnet containing material such as end-of-life motors, hard drives, partially deconstructed motors, magnet-containing end-of-life product, or parts thereof, and outputting magnetic components by exploiting magnetic properties of ferromagnetic and paramagnetic materials in the presence and absence of electromagnetic fields in conjunction with other physical properties such as size and density. The system also includes a chemical processing unit for receiving the magnetic components to extract rare earth elements in the material. Chemical processes are disclosed for separating rare earth elements from magnetic components.

### FIELD

The disclosure relates generally to recycling and in particular to systems and methods for recycling magnets and valuable elements contained therein including rare earth elements.

### BACKGROUND OF THE DISCLOSURE

Magnetic material and many elements contained within such materials including rare earth elements (REEs) play an increasingly critical role in the manufacturing of many of the tools that are necessary to thrive in an advanced economy, ranging from smartphones and high performance magnets to electric vehicles.

The availability of REEs has been constrained by an increased demand, and an insufficient increase in production capacity, resulting in a growing concern that the global economy risks facing a severe shortage of the rare earth elements.

In addition, the increasing importance of climate change has led to the realization that green technologies will become more widely adopted as the only means of achieving sustainability for producing and consuming energy.

Recycling of valuable commodities contained within magnets, such as, but not limited to, rare earth elements thus mitigates each of the aforementioned problems and complements solutions thereto. Recycling is an inherently sustainable method of resource production and clearly reduces demand for new sources of REEs. This in turn eases the constraint on supply chains.

One of the main challenges to recycling rare earth elements is the cost required to purify mixtures obtained from consumer and other discarded devices that contain REEs.

It is thus desirable to have improvements in the recovery and recycling of critical rare earth elements to reduce the environmental impact of the global energy transition.

### SUMMARY OF THE DISCLOSURE

In accordance with one aspect of the present invention, there is provided a system for producing a magnet concentrate containing rare earth elements, the system comprising: i) a size reduction unit, for receiving discarded waste containing magnetic material to output mixed scrap, the mixed scrap containing magnetic components and nonmagnetic components; ii) a target magnetic materials extraction block, for receiving and separating the mixed scrap into target magnetic material and non-target material; and iii) a chemical processing unit comprising a) an input for receiving a mixed feed comprising the target magnetic material; b) an acid leaching unit for acid leaching the mixed feed; c) a rare earth element removal unit for removing rare earth elements from the mixed feed via precipitation as an oxalate, carbonate, or other rare earth salts; d) a calcination unit for calcining of the rare earth salts to rare earth oxide; and e) one or more particle removal units for: 1) iron removal by pH adjustment and precipitation; 2) removal of one or more of nickel, cobalt, other transition metals by solvent extraction, pH adjustment, and precipitation as a hydroxide; 3) removal of copper by precipitation, by solvent extraction, or by ion exchange; and 4) removal of boron by solvent extraction or ion exchange, wherein the target magnetic material include rare earth element(s) containing magnets, such as but not limited to, neodymium magnets and samarium cobalt magnets and cobalt and/or nickel containing magnets such as, but not limited to aluminum nickel cobalt magnets, or any combination thereof.

In accordance with another aspect, there is provided a method for obtaining rare earth elements, the method comprising: (i) milling mixed scrap material containing magnets to a milled material of pre-determined size; (ii) capturing dust generated by said milling in a dust collector; (iii) re-magnetizing the milled material; (iv) vibrating the milled material to promote mixing; (v) passing the milled material over a set of N screens to produce N+1 product fractions, the fractions comprising oversize fraction containing a first set of magnet clumps and fine dust fraction; (vi) combining the fine dust fraction with the dust from the dust collector to form a dust stream; (vii) passing the dust stream through a circuit containing re-magnetizing-clumping-screening to output fine particles comprising a second set of magnet clumps; (viii) short grinding of the magnetic clumps and then screening to capture the magnetic material in the small size fraction of the screen as the mixed feed; (ix) acid leaching the mixed feed; (x) rare earth element removal by precipitation as an oxalate, carbonate, or other rare earth salts; (xi) calcining of the rare earth salts to rare earth oxide; (xii) iron removal by pH and temperature adjustment and precipitation; (xiii) removal of one or more of nickel and cobalt by solvent extraction, pH adjustment and precipitation as an oxide or hydroxide; (xiv) removal of copper by precipitation or solvent extraction; and (xv) removal of boron by solvent extraction or ion exchange.

In accordance with yet another aspect of the present disclosure, there is provided a system comprising (i) a size reduction unit for receiving one or more of any magnet-containing end-of-life products, discarded electric motors (including a subcategory known as ELMO), hard disk drives, and meatballs (partially-deconstructed or shredded electric motors, also known as SHELMO) to output mixed scrap having magnetic and non-magnetic components; and (ii) a target magnetic materials extraction block for receiving the magnetic components and separating the magnetic components into target magnetic material and non-target material; wherein the target magnetic materials are an end product to be processed separately.

In accordance with yet another aspect of the present disclosure, there is provided a method of preparing a magnet concentrate. The method includes: obtaining feed material containing magnetic material, the magnetic material comprising ferromagnetic material and non-ferromagnetic material; reducing the size of the feed material; separating the reduced size feed material into the ferromagnetic material and the non-ferromagnetic material; and separating the ferromagnetic material into a target magnetic material concentrate (also referred to as “magnet concentrate”) and a non-target magnetic material depleted scrap.

In accordance with yet another aspect, there is provided a method of preparing a magnet concentrate. The method includes one or more of: milling mixed scrap material containing magnets to a milled material of pre-determined size; capturing dust generated by milling in a dust collector; re-magnetizing the milled material; vibrating the milled material to promote mixing; passing the milled material over a set of N screens to produce N+1 product fractions, the fractions comprising oversize fraction containing a first set of magnet clumps and fine dust fraction; combining the fine dust fraction with the dust from the dust collector to form a dust stream; passing the dust stream through a circuit containing re-magnetizing-clumping-screening to output fine particles comprising a second set of magnet clumps; rapid grinding the magnet clumps and screening, collecting the smallest size fraction as the target magnetic material concentrate; and combining the fine particles to form the magnet concentrate.

In accordance with another aspect of the present disclosure, there is provided a system for obtaining rare earth elements comprising: (i) a milling/washing block for receiving swarf and discarded magnet material and outputting magnetic components; and (ii) a chemical processing unit for receiving magnetic components from one or more of a target magnetic materials extraction block and the milling/washing unit to extract rare earth elements in the material.

In another aspect, there is provided a process for obtaining rare earth elements from a mixed feed, the process comprising: acid leaching the mixed feed; rare earth element removal by precipitation as an oxalate, carbonate, or other rare earth salts; calcining of the rare earth salt to rare earth oxide; iron removal by pH adjustment and precipitation; removal of one or more of nickel, cobalt, other transition metals by solvent extraction, pH adjustment, and precipitation as a hydroxide; removal of copper by precipitation, by solvent extraction, or by ion exchange; and removal of boron by solvent extraction, ion exchange, or precipitation.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 shows a simplified block diagram of a system for use in recycling materials including rare earth elements, from discarded motors, hard disk drives, and other waste in accordance with an embodiment;

FIG. 2 is a schematic diagram showing various physical components of an embodiment of a system for separating magnetic and nonmagnetic components;

FIG. 3 is a schematic diagram showing various physical components of another embodiment of a system for separating magnetic and nonmagnetic components;

FIG. 4 is a schematic diagram showing various physical components of another embodiment of a system for separating magnetic and nonmagnetic components;

FIG. 5 is a schematic diagram showing various physical components of another embodiment of a system for separating magnetic and nonmagnetic components having a belt-mounted magnetizer/demagnetizer;

FIG. 6 is a schematic block diagram of a process for producing a magnet concentrate by screening out clumps of magnet material in accordance with an embodiment and includes pictures of processed material with the magnetic clumps on the far left and progressively smaller size fractions to the right;

FIG. 7 is a flowchart of a specific process in accordance with one embodiment of the process of FIG. 6;

FIG. 8 is a schematic diagram showing various physical components of another embodiment of a system for separating magnetic and nonmagnetic components having a magnetic detector and a computing device for signal processing;

FIG. 9 is a block diagram of various physical elements of computer device of FIG. 8;

FIG. 10 illustrates schematic block diagrams illustrating variations of embodiments involving selective calcination of a mixed oxalate;

FIG. 11 is a schematic illustration of an embodiment of a cleaning process of swarf;

FIG. 12 is a flowchart of a process combination used to output an enriched magnet concentrate from mixed scrap material; and

FIG. 13 is a flowchart of chemical processing steps used to convert a variety of magnet-containing feeds into a rare earth concentrate in one embodiment;

FIG. 14 is a flowchart of another embodiment of the process of FIG. 13, comprising additional steps; and

FIGS. 15-17 depicted flow diagrams associated with the system of FIG. 1.

Unless otherwise specifically noted, articles depicted in the drawings are not necessarily drawn to scale.

### DETAILED DESCRIPTION

The presented technology processes a variety of end-of-life devices to capture value from the content of the contained commodities. Such devices include, but are not limited to, electric motors, hard drives, and/or meatball (partially deconstructed motors), and any magnet-containing end-of-life products or any parts thereof.

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

### System Overview

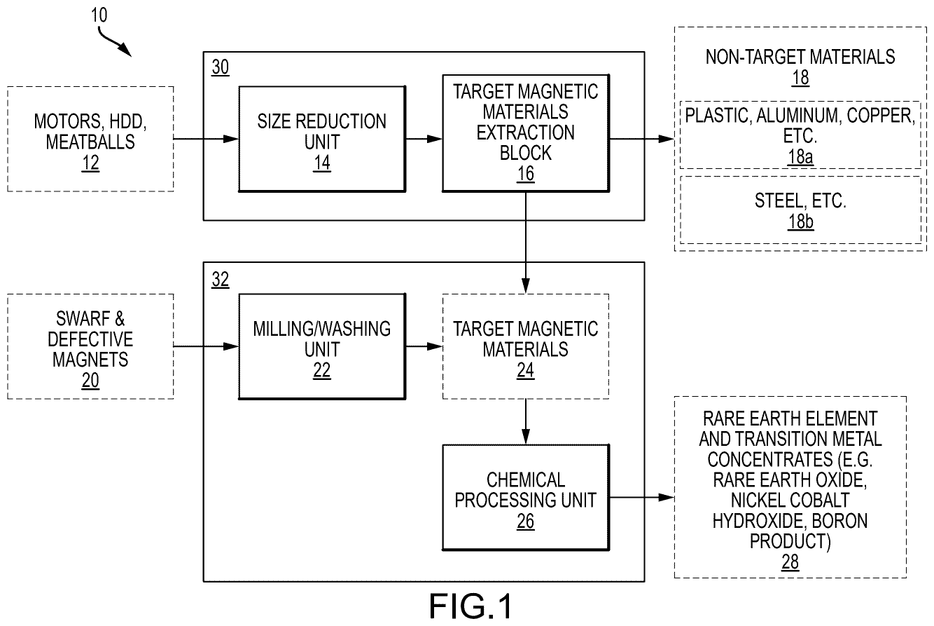

A simplified block diagram of a system 10 for use in recycling materials including magnets and rare earth elements, from discarded motors, hard disk drives, and other electromechanical waste in accordance with an embodiment is depicted in FIG. 1.

As shown, system 10 includes a first subsystem 30 for receiving discarded waste 12 and separating them into magnetic and non-magnetic components, and a second subsystem 32 for receiving a magnet concentrate from subsystem 30 as well as swarf and defective magnets and obtaining a rare earth element concentrate.

Subsystem 30 includes a size reduction block 14 and a target magnetic materials extraction block 16. Size reduction block 14 reduces the received waste 12 in size, in a controlled manner that is suitable for further processing, such that magnets are mostly preserved. Traditional crushing, smashing or pulverization of materials containing magnets in an uncontrolled environment may lead to loss of magnets, which may stick to surrounding objects exhibiting ferromagnetic properties.

At target magnetic materials extraction block 16, target magnetic materials 24 are separated or extracted from the reduced material at the output of block 14. Target magnet materials 24 include rare earth element(s) containing magnets, such as but not limited to, neodymium magnets and samarium cobalt magnets and cobalt and/or nickel containing magnets such as, but not limited to aluminum nickel cobalt magnets, or any combination thereof. The target magnetic materials extraction block 16 may separately extract non-target materials 18 and target magnetic materials 24. Non-target materials 18 include non-magnetic materials 18a (such as plastic, aluminum, copper) and non-target magnetic materials 18b such as steel. Non-target materials 18 may include forms of steel, copper, aluminium, and plastics and non-metallics.

System 10 also includes a second subsystem 32, that is an example of an embodiment of the present disclosure, for receiving discarded waste 20 in the form of swarf, defective and/or magnets that are not usable in their current state. A milling/washing block 22 in subsystem 32 receives the swarf, defective magnets and/or currently unusable magnets, and outputs target magnetic material 24. These target magnetic materials 24 may include diamagnetic, ferromagnetic, and paramagnetic components. As used in this document, target magnetic material includes rare earth element(s) containing magnets, such as but not limited to neodymium magnets and samarium cobalt magnets and cobalt and/or nickel containing magnets such as, but not limited to aluminum nickel cobalt magnets, or any combination thereof. Swarf may not require milling and may bypass milling/washing block 22 and be presented directly as forming part of target magnetic materials 24. Defective magnets and large magnets may or may not require demagnetizing before being provided to milling/washing block 22.

Target magnetic materials 24 may therefore result from one or both target magnetic materials extraction block 16 of subsystem 30 and milling/washing block 22 of subsystem 32. As depicted in FIG. 1, some or all of the target magnetic materials 24 may also be obtained directly from swarf and unusable magnets in discarded waste 20 without necessarily going through the milling block 22. The target magnetic materials 24 are further processed in a chemical processing block 26 to obtain rare earth element and transition metal concentrates 28. Chemical processing block 26 may include sub-blocks for hydrometallurgical and non-hydrometallurgical steps. The concentrates may include, for example, rare earth elements, cobalt, nickel, iron, copper, zinc, and boron.

Conventional operations process these end-of-life devices and separate them into base metals, typically, copper, aluminum, and steel. Embodiments of the present disclosure, however, achieve the separation of valuable magnet material that currently travels with the steel in existing processes as depicted in FIG. 1.

Several embodiments of systems and/or methods for separating valuable magnet materials are described in the present disclosure, with reference to several specific embodiments, as disclosed below.

Preliminary research has demonstrated that various application of the described embodiments has upgrade material from approximately less than 6% magnet to 30% magnet or higher. Refinement of the technique may achieve magnet upgrading to 100%.

### Embodiment 1—Separation of Magnets From Steel Using a Ferromagnetic Gathering Surface

According to a first set of embodiments, there are provided systems and methods of separating magnets from steel using a ferromagnetic gathering surface. It is well known that magnetized material is attracted to steel. In one embodiment, this property is exploited to selectively sort magnets from mixed scrap material including from ferrous material.

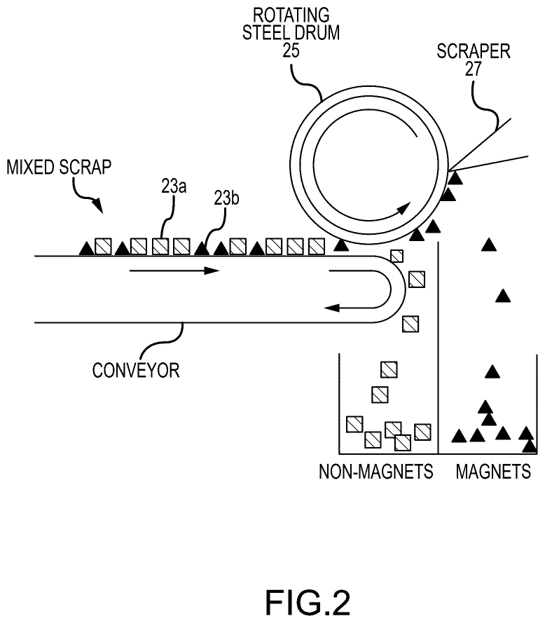

In one embodiment, illustrated in FIG. 2, milling is used to form small discrete components of consistent size of a mixed scrap 23. The components of mixed scrap 23, which include non-magnetized components 23a and magnetized components 23b, are conveyed along a non-ferromagnetic belt such as a rubber belt, which passes underneath, and may be in physical contact with, a rotating or revolving steel drum 25. The magnetized components stick to the drum and are scraped off for collection by a scraper 27.

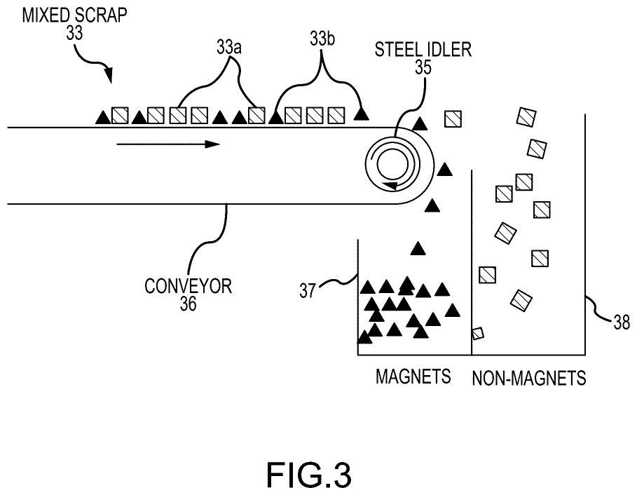

In another embodiment, illustrated in FIG. 3, a mixed scrap 33 containing non-magnetized components 33a and magnetized components 33b is conveyed on a variable speed thin non-ferromagnetic belt conveyor 36.

At the end of the conveyor 36 the belt passes over a steel idler 35 that exerts passive attraction on any magnetized components 33b within the mixed scrap 33. As a result of the magnetic force of attraction, magnetized components 33b are thrown a shorter distance off the belt, whereas non-magnetized material is thrown further, allowing the discrete components of the material to be sorted into magnetized and non-magnetized components within two bins 37, 38 respectively. The relative magnitude of this effect can be controlled by varying the speed of the belt.

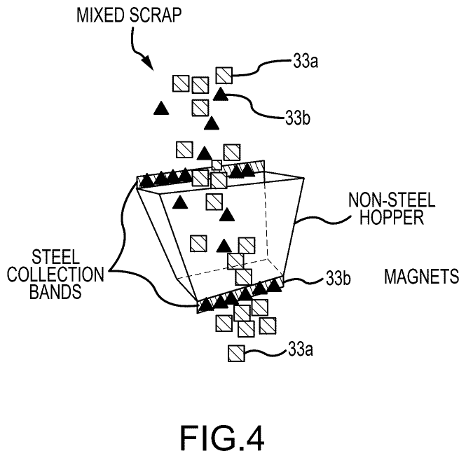

In another embodiment depicted in FIG. 4, mixed scrap is slid down a gently sloped vibrating steel plate. Magnetized particles are attracted to the steel plate and therefore slide more slowly than non-magnetized particles. The discrete components of the material partitions into two cuts, one enriched in magnets.

Variations of the above three embodiments may include a steel surface that is a pulsing electromagnet. A powerful but temporary magnetic field exerts an attractive force on all ferromagnetic material in the mixed scrap. Once the magnetic field is turned off, however, the non-magnetized ferrous components fall away, leaving the magnetized components stuck to the steel surface.

To facilitate the above embodiments, any parts of a scrap processing line that are typically made from steel, such as the feed and discharge chutes of the mill, are replaced with non-ferromagnetic materials, such as fibreglass or stainless steel. A ferromagnetic “collection band” is then added as a collection point for lightweight magnetic particles. The magnetic particles are periodically harvested with a scraper.

In other words, all of the above embodiments may be enhanced by ensuring that there are no competing ferromagnetic surfaces for the magnetic components from the mixed scrap to adhere to. This may involve, for example, replacing steel conveyor belt rollers with nylon rollers, replacing steel chutes with fiberglass chutes, and replacing carbon steel mechanical parts with stainless steel parts. Adjacent equipment such as mills, conveyors, chutes and storages may be modified or redesigned accordingly.

In some embodiments, fragmented magnets may be too weakly magnetic to be sufficiently attracted to a steel surface or plate, even if the fragmented magnets come into direct contact. Moreover, a significant amount of bulk ferrous material may follow the magnets. In such cases, the embodiments may be used for partial upgrading step of the scrap mix, which will further be processed.

### Embodiment 2—Use of Demagnetization and Re-Magnetization to Separate Magnets From Steel

As noted above, magnetized material is attracted to steel. Accordingly, in a conventional scrap processing line, the magnetic components follow the steel through the process. In sharp contrast to conventional scrap processing, in one embodiment, the magnetic components are demagnetized, and subsequently separated from steel by exploiting their other properties, such as size and/or density, or even via conventional magnetic separation.

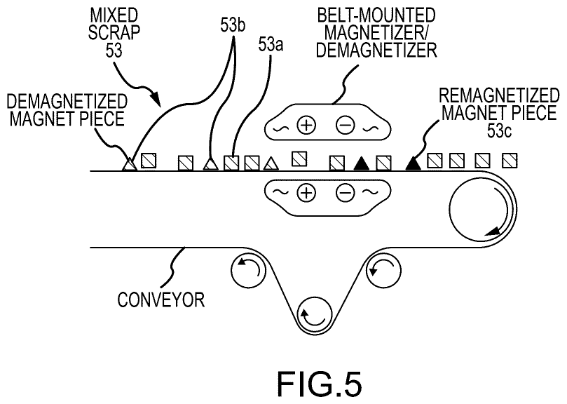

A magnet can be demagnetized thermally or by exposure to an oscillating diminishing magnetic field or by hammering action of size reduction process. In one embodiment depicted in FIG. 5, the mixed scrap material is passed over an electric demagnetizing pad installed underneath a conveyor belt. In a variation of the above embodiment, the mixed scrap material is passed through an electric demagnetizing cylinder. In another variation of the above embodiment, the mixed scrap material is passed through a heating furnace.

The resulting demagnetized material is then subjected to a conventional separation method. The downstream process may be able to distinguish between magnetic materials, allowing for the rejection of undesired ferrite magnets and/or steel.

In the embodiment depicted in FIG. 5, re-magnetization of demagnetized magnets may be used. Ferromagnetic material can be magnetized by exposing it to a magnetic field. Material magnetized in this way may retain its magnetism permanently or temporarily. In one embodiment, a mixed stream 53 of non-ferrous material containing a small amount of unmagnetized magnet material 53b is re-magnetized. The re-magnetized magnets 53c are then selectively pulled using a ferromagnetic gathering surface, as described above.

### Embodiment 3—A Method to Create a Magnet-Enriched Concentrate From Scrap Steel by Milling, Re-Magnetizing/De-Magnetizing, Clumping, and Screening

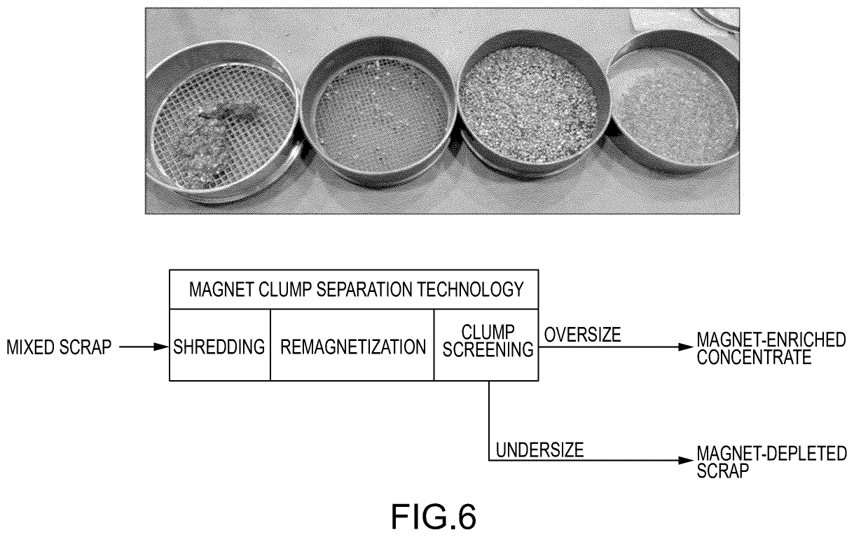

In another embodiment, a method of creating a magnet-enriched concentrate from scrap steel is provided. Magnets or pieces of magnets attract ferromagnetic material such as steel. If mixed scrap that contains magnets is milled to a small size (e.g. less than 5 cm, less than 1 cm, less than 5 mm, or between 1 mm and 50 mm), the small pieces of magnets will attract pieces of steel and steel dust to form a larger, loosely-bound, dough-like “clump”. The magnet material concentrates inside the clumps, while the surrounding matrix material becomes relatively depleted of magnets. A magnet concentrate can be produced by screening out the clumps. A schematic block diagram of an embodiment of the process is illustrated in FIG. 6.

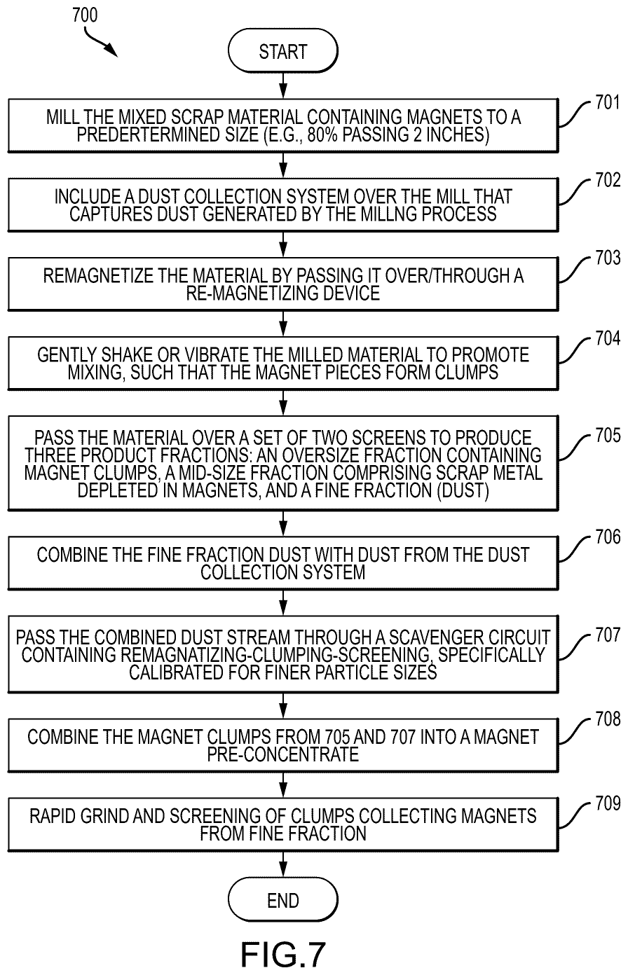

In one specific embodiment, a process 700 depicted in FIG. 7, may involve one or more of the illustrated steps. At step 701, mill the mixed scrap material containing magnets to a pre-determined size (e.g., 80% passing 2 inches) or for a pre-determined time. At step 702, a dust collection system may be utilized over the mill to capture dust generated by the milling process. As a third step 703, the material may then be re-magnetized by passing it over or through a re-magnetizing device or by passing it over a magnetic field. In one embodiment, the re-magnetizing device may be a magnet, which may be a strong magnet, and the step of re-magnetizing may include passing the material over a re-magnetizing device or the magnet. A fourth step 704 involves shaking or vibrating the milled material to promote mixing, such that the magnet pieces form clumps. The shaking may be done in a gentle manner. At a fifth step 705, the material may then be passed over a set of screens to produces several product fractions. In the depicted embodiment, two screens are used to produce three fractions. However, more generally, in other embodiments, N screens may be used to produce N+1 fractions. The order of these steps may be different than the example embodiment described.

In one specific embodiment, screens are used to produce three product fractions, namely: an oversize fraction containing magnet clumps; a mid-size fraction containing of scrap metal depleted in magnets; and a fine fraction (dust). In one specific embodiment the clumps are de-magnetized and milled to a pre-determined size or for a pre-determined time and screened.

The process 700 may further include a sixth step 706 to combine the fine fraction dust with dust from the dust collection system. As a seventh step 707, the process 700 then passes the combined dust stream through a scavenger circuit that may also include of re-magnetizing-clumping-screening, specifically calibrated for finer particle sizes.

As an eighth step 708, the magnet clumps from step 705 and step 707 may then be combined into a magnet pre-concentrate.

At step 709, rapid grind and screening of clumps occurs collecting magnets from fine fraction. The process then terminates.

As noted above, all or only a subset of the illustrated steps of process 700 may be undertaken.

The ferrous and magnet material may be further upgraded by grinding and the material. A short duration grind has been demonstrated to reduce the size of magnets rapidly, with minimal size reduction of the ferrous material. Screening of this material further concentrates the magnets in the fine fraction.

An alternative upgrading method that may be used with or without the above mentioned refining, demagnetizes the agglomerations, and while the material is at temperature, separates the steel from the magnets using magnetic separation. Conducting magnetic separation at temperature exploits the differences in magnetic attraction of steel and magnets at high temperatures and can be used to concentrate the material.

### Embodiment 4—Paramagnetic Upgrading of Mixed Oxides to Produce a REE Oxide Concentrate

Iron oxide and rare earth element oxides (REE oxides) are paramagnetic, meaning they are weakly attracted to a magnetic field. It is possible to separate different paramagnetic materials from one other by exploiting their differing magnetic susceptibilities (χm) using a very strong magnetic field. The table below lists a measure of magnetic susceptibilities of different materials.

| Material | χm, 10⁻⁶ cm³ mol⁻¹ | Remarks |
|---|---|---|
| Iron metal | Infinite | Ferromagnetic |
| Iron(II) oxide | +7,200 | Paramagnetic |
| Neodymium metal | +5,930 | Paramagnetic |
| Neodymium oxide | +10,200 | Paramagnetic |

### Embodiment 5—Mechanical Sorting of Magnets From Mixed Scrap Using Magnetic Field Detection

As is well known, while permanent magnets produce a magnetic field, steel, by itself, does not. In one embedment, these properties are utilized as follows. An array of magnetic field sensors (e.g., magnometer or Gauss meter) is provided to build a topographic map of magnetic field strength of a mixed scrap on a moving conveyor. Signal processing is then employed to analyze images of the mixed scrap, and to infer locations of magnets within a mixed scrap containing magnetic components and steel fragments. A mechanical method such as an air jet may then be used to segregate the magnets based on the inferred locations.

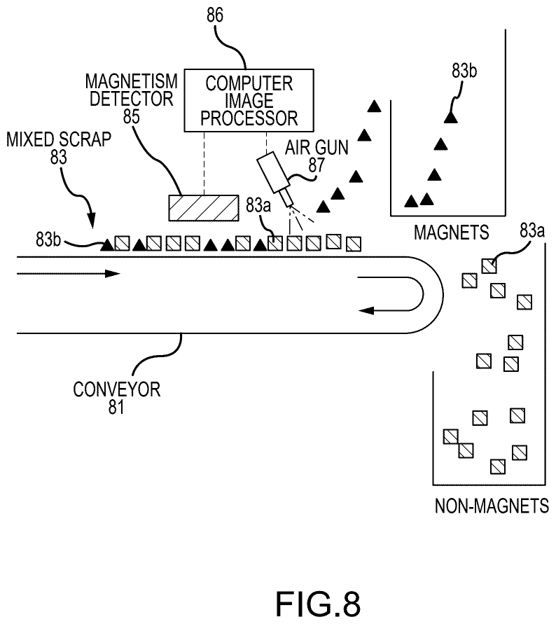

One specific embodiment includes four parts for magnet sorting: stimulation, sensor, signal processing, and mechanical sorting. FIG. 8 depicts one specific embodiment. Mixed feed material 83 is moved in a thin layer along a conveyor belt 81 and images of the material are captured by a detector or a sensor 85 similar to digital camera, that is capable of capturing and representing the magnetic field within its field of view.

A computing device 86 executing a proprietary software algorithm is then used to processes the images to identify the location of the magnets. A mechanical device 87, which may be an air gun in this embodiment, is then employed to pick out the desired magnetic components. A subsystem comprising the sensor 85, computing device 86 including the software may be formed as a stand-alone system. The stand-alone subsystem above may be deployed exclusively for internal use as part of a conveyor, or alternately may be built as a separate equipment package suitable for use by scrapyards. This embodiment may require a detector having a sensor capable of representing magnetic fields. The associated signal processing may present difficulties, as the raw magnetic field map may appear to resemble undulating hills rather than clear peaks. Likewise, a wide distribution of small magnet particles or dust may generate a broad, weak signal that might be difficult to distinguish from background noise. Persons of skill in the art of magnetic fields expect that the signals obtained from such a setup would be very noisy. Further, ferrous material may be magnetically attracted to the magnets and remain stuck during said mechanical sorting, resulting in high contamination of the magnet concentrate.

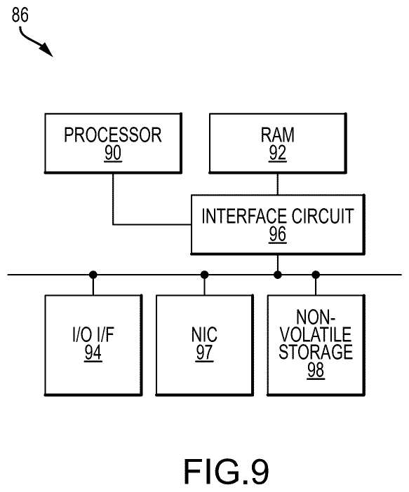

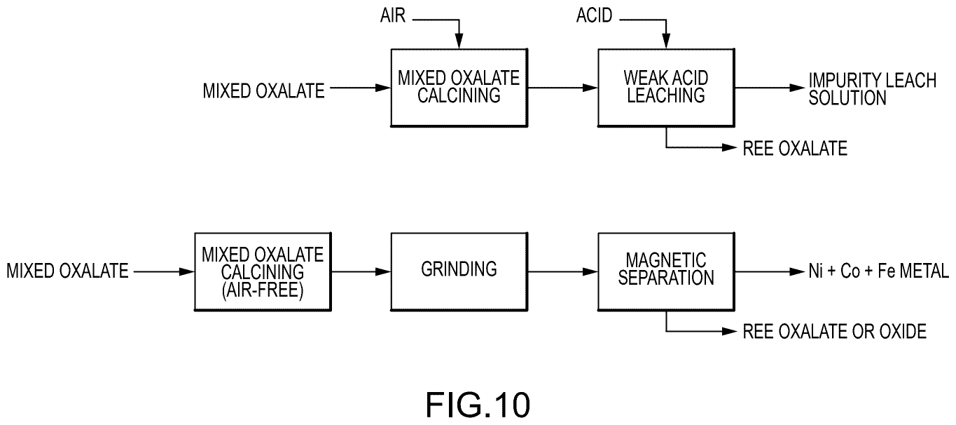

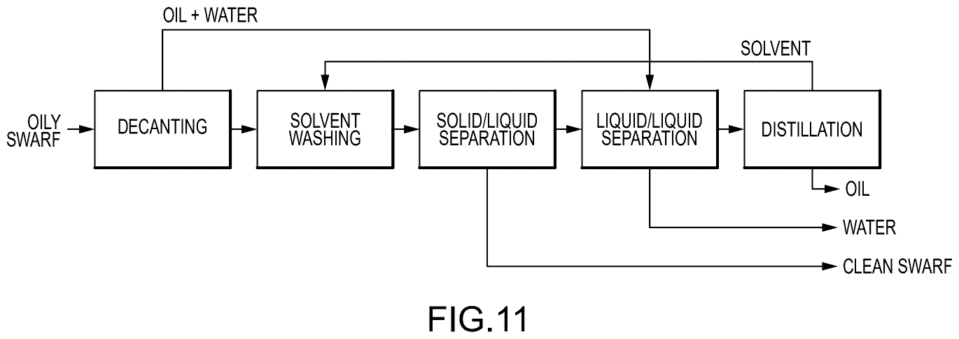

FIG. 9 shows various physical elements of computer system 86 of FIG. 8. As shown, computer system 86 has a number of physical and logical components, including a processor 90, memory 92 which may be in the form of random access memory (“RAM”), an interface circuit 96, an input/output (“I/O”) interface 94, a network interface 97, non-volatile storage 98. Interface circuit 96 enabling processor 90 to communicate with the other components. Processor 90 executes at least an operating system, and a proprietary software noted above for analysing images of magnetic fields or related properties captured by sensor 85. Memory 92 provides relatively responsive volatile storage to processor 90. I/O interface 94 allows for input to be received from one or more devices, such as a keyboard, a mouse, etc., and outputs information to output devices, such as a display and/or speakers. Network interface 97 permits communication with other computing devices over computer networks such as Internet. Non-volatile storage 98 stores the operating system and programs, including computer- executable instructions for implementing the software. During operation of computer system 86, the operating system, the programs and the data may be retrieved from non-volatile storage 98 and placed in memory 92 to facilitate execution.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

### Overall Mechanical Process

In one embodiment, an overall process combines a series of individual physical processing steps in a unique combination that is able to output an enriched magnet concentrate from mixed scrap material.

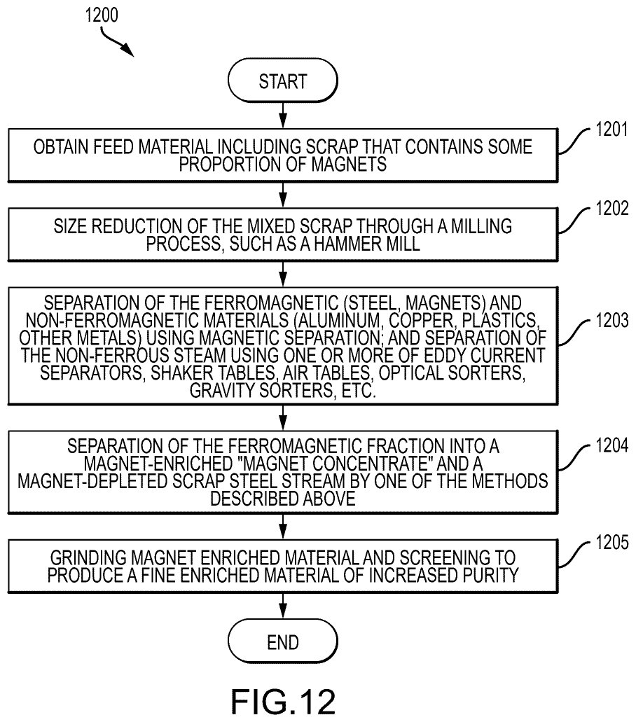

The process 1200 is summarized in FIG. 12 and comprises the following steps:

At step 1201 feed material comprising scrap that contains some proportion of magnets is obtained.

At step 1202 size reduction of the mixed scrap through a milling process, such as a hammer mill, takes place.

At step 1203 separation of the ferromagnetic (e.g., steel, magnets) and non-ferromagnetic materials (e.g., aluminum, copper, plastics, other metals) using magnetic separation is undertaken and further separation of the non-ferrous steam is achieved using one or more of eddy current separators, shaker tables, air tables, optical sorters, gravity sorters, etc.

At step 1204, separation of the ferromagnetic fraction into a target magnetic materials-enriched “magnet concentrate” and a non-target magnetic materials-depleted scrap steel stream by one of the methods described above occurs.

Step 1205 involves grinding target magnetic materials enriched material and screening to produce a fine enriched material of increased purity.

The process 1200 then terminates.

### Chemical System/Processes

Some embodiments of the system disclosed herein, although characterized as chemical processes, may contain steps or processes that also exploit physical properties of the material components. A description of each of the process constituents is provided below, although the order and use of the process constituents may change.

Certain specific terms for steps or processes used throughout the present description may be read and understood as follows, unless the context indicates otherwise.

### Grinding

To facilitate reaction kinetics, magnet material is comminuted and screened to ensure a target particle size, such as 80% passing 100 microns. Comminution typically generates heat and for some materials, such as neodymium magnets or other metals, the attendant dust particles produced may be flammable and/or explosive. To eliminate or at least reduce this risk several methods may be used including but are not limited to the addition of water, dry ice, nitrogen gas, argon, and carbon dioxide or a combination thereof. The use of water and dry ice may act to reduce the heat below the temperature of combustion, and the use of the gasses may act to limit the availability of oxygen, while the use of dry ice may act to reduce heat and limit the availability of oxygen.

### Washing

A valuable feed source for magnet recycling includes swarf, which is a manufacturing waste product. Swarf is typically mixed with a liquid used as a cutting or cooling aid, such as a cutting oil. Swarf may be washed using, water, heated water, surfactants, such as but not limited to sodium dodecylsulfate, Alconox®, Alcojet®, Detergent 8, and Detonox®, and/or other reagents including but not limited to: dichloromethane, that breakdown organic material. Washing procedures have been tested and efficacies range from removing 70% to 100% of the entrained cutting liquid.

### Roasting

To facilitate the removal of impurities, the magnet material may be roasted at a temperature that varies between 150° C. to 1000° C. to alter the oxidative state of impurities.

### Leaching

The leaching process utilizes a lixiviant, which may include but is not limited to: hydrochloric acid, sulphuric acid, nitric acid, and/or organic acids or a combination thereof. To date, leaching tests have demonstrated extraction efficiencies of up to 100% of the contained critical minerals, that includes rare earth elements, cobalt, and nickel, by controlling temperature, reaction time, and using an oxidizing agent. Control of some or all of these operating parameters may be used or not used.

### Iron Removal

Iron and other impurities may be precipitated from the process solution by adjusting the solution pH with calcium oxide, calcium hydroxide, calcium carbonate, magnesium oxide, magnesium hydroxide, magnesium carbonate, sodium hydroxide, or other alkaline reagents or minerals, or a combination thereof in an oxidative environment achieved by the use of air, oxygen gas, or hydrogen peroxide, mixture of SO₂ with oxygen or air gasses, permanganate, or other known oxidants in the industry or a combination thereof. The addition of copper ions and the use of solvent extraction may also be applied. To date, test work has achieved removal of up to 99% iron in solution.

### Oxalate Precipitation

The production of a rare earth element (REE) material may be achieved by precipitation as an oxalate or a carbonate. Such a precipitation may also target a high purity product by dosing the solution with 50% to 500% the stoichiometric addition of the precipitating reagent. The use of solvent extraction to separate the REEs may also be applied. To date laboratory work has achieved 95% or more purity of a REE product.

### REE Solvent Extraction

REE solvent extraction may be used to remove trace levels of impurities for solution to produce a high purity solution from which the REEs can be precipitated as a high purity product. This process may utilize extractants such as, but not limited to, CYANEX® 272, tributyl phosphate (TBP), Di-(2-ethylhexyl) phosphoric acid (DEHPA), 2-ethylhexylphosphonic acid mono-2-ethylhexyl ester (PC88A), CYANEX® 801, and/or CYANEX® 905B or a combination thereof.

### Calcination

The conversion of oxalate and/or carbonates to an oxide is achieved by calcination. This process may include selective calcination by targeting temperature associated with the conversion of specific species, temperatures may range from 150° C. to 1200° C. To date, calcinations at 650° C. have been used to produce rare earth products of 95% purity or more.

### Impurity Removal

Trace level of impurities can have an adverse impact on the usability and value of high purity products. Removal of aluminum, copper, zinc, and other impurities may be accomplished using precipitation with calcium oxide, calcium hydroxide, magnesium oxide, magnesium hydroxide, sodium hydroxide, or other alkaline reagents, or a combination thereof. Solvent extraction and ion exchange may also be used to remove trace impurities.

### Cobalt and Nickel Removal

Cobalt and nickel are valuable critical materials and can be separated form the process solution using solvent extraction and/or precipitation as a hydroxide using a reagent such as, but not limited to, lime or sodium hydroxide, and magnesium hydroxide, producing a mixed cobalt-nickel hydroxide product.

### Boron Removal

Boron is removed from the process solution using ion exchange or solvent extraction to produce products such as, but not limited to, zinc borate, boric acid, and/or sodium borate

### Selective Precipitation of Rare Earth Oxalates From Iron-Rich Leach Solutions by Controlling Oxalate Addition

In one embodiment, a process for selective precipitation of rare earth oxalates from iron-rich leach solutions involves controlling oxalate addition. When mixed magnets are leached in acid, the pregnant leach solution may contain many metals, including REEs, iron, aluminum, copper, nickel, and others. The separation of these metals from one another is desirable to ensure the quality of the REE product meets predefined specifications for their intended application.

One method of rare earth separation is REE oxalate precipitation. Unfortunately, many other metals also precipitate as oxalates, requiring the resultant contaminated product to be further refined.

In the course of experimental work, it was observed that REE oxalates tend to precipitate first, followed by iron oxalates. In one embodiment of a process utilizing this observation, iron may be rejected by carefully controlling the amount of oxalate that is added to the leach solution to nearly match, or be slightly above, the amount of REEs. The embodiment involves pairing the monitoring of REE concentration in the leach solution with exact dosing of oxalate, such that REE precipitation is increased/maximized and iron precipitation is reduced/minimized.

### Selective Calcining of a Mixed Oxalate Precipitate Followed by Separation of Impurities

In another embodiment, selective calcining of a mixed oxalate precipitate is followed by steps for separating impurities. REEs can be recovered from a leach solution by oxalate precipitation. This mixed oxalate precipitation process, even if tightly controlled, may produce a product that contains some impurities. The conventional approach to purify the oxalate is to calcine it to an oxide and re-leach it, followed by hydrometallurgical purification.

Selective calcination of a mixed oxalate is a novel alternative to re-leaching that may achieve the same result at lower cost. Nickel, cobalt, and iron oxalates thermally decompose at a lower temperature than rare earth oxalates. The different properties of the different components of the decomposition product can then be exploited to purify the product.

There are several variations of this embodiment. In one variation, a mixed oxalate precipitate containing rare earth elements and transition metal impurities is calcined between 150 and 1200° C. The resulting calcined product is then purified by leaching, washing, magnetic separation, or slag refining. The calcined product is leached in weak acid to remove the impurities, leaving behind REE oxalate. FIG. 2 depicts schematic block diagrams illustrating the above variations.

### Cleaning of Swarf From Magnet Manufacturing and Recovery of Oil Through Solvent Washing And Distillation

Magnet manufacturing swarf involves metal pieces soaked in oil and water. This is then cleaned before it can be fed to the process of FIG. 1.

In the embodiment depicted in FIG. 3, during the cleaning process, a volatile solvent or water (individually and collectively referred to as “solvent”) is mixed with the swarf to dissolve and/or separate all oil. The swarf is then separated from the solvent by settling and decantation, followed by a final wash with more solvent.

The oil-loaded solvent is then distilled to recover and recycle the solvent, and the residual oil is sold or disposed.

Non-limiting examples of a volatile solvent is include trichloroethylene and d-Limonene.

### Overall Chemical Process

In another embodiment, an overall chemical process, combines a series of chemical processing steps to convert a variety of magnet-containing feeds into a rare earth concentrate as well as optional secondary concentrates of iron, nickel, cobalt, boron or other elements.

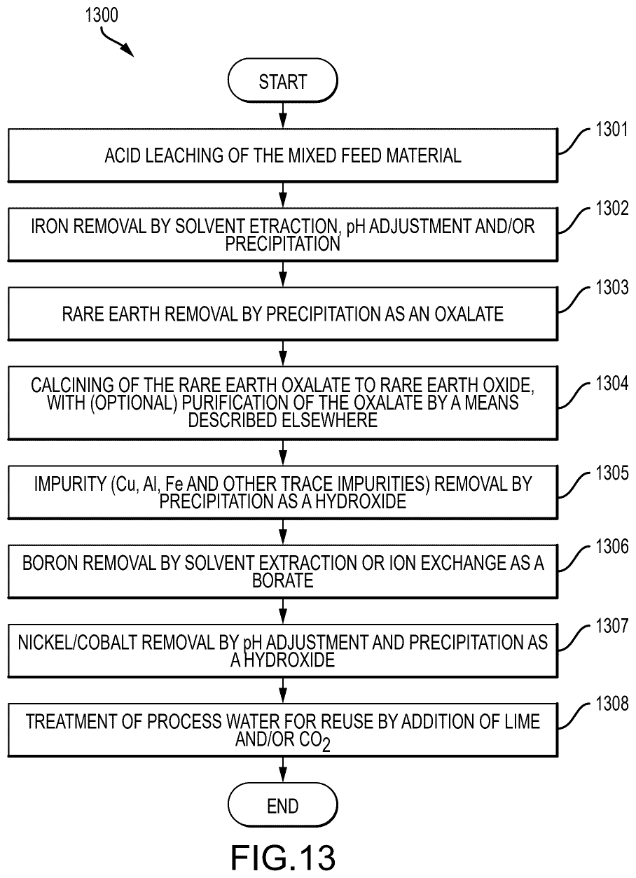

An exemplary process 1300 is summarized in FIG. 13.

Step 1301 involves acid leaching of the mixed feed material as noted above.

Step 1302 involves iron removal by pH adjustment and precipitation.

Step 1303 involves rare earth removal by precipitation as an oxalate.

Step 1304 involves calcining of the rare earth oxalate to rare earth oxide by a means described elsewhere.

Step 1305 involves impurity removal (i.e., removal of Cu, Al, Fe, and other trace impurities) by precipitation as a hydroxide.

Step 1306 includes boron removal by solvent extraction or ion exchange.

Step 1307 involves nickel/cobalt removal by pH adjustment and precipitation as a hydroxide.

Step 1308 involves treatment of process water for reuse by addition of lime and/or CO2. The process 1300 then terminates.

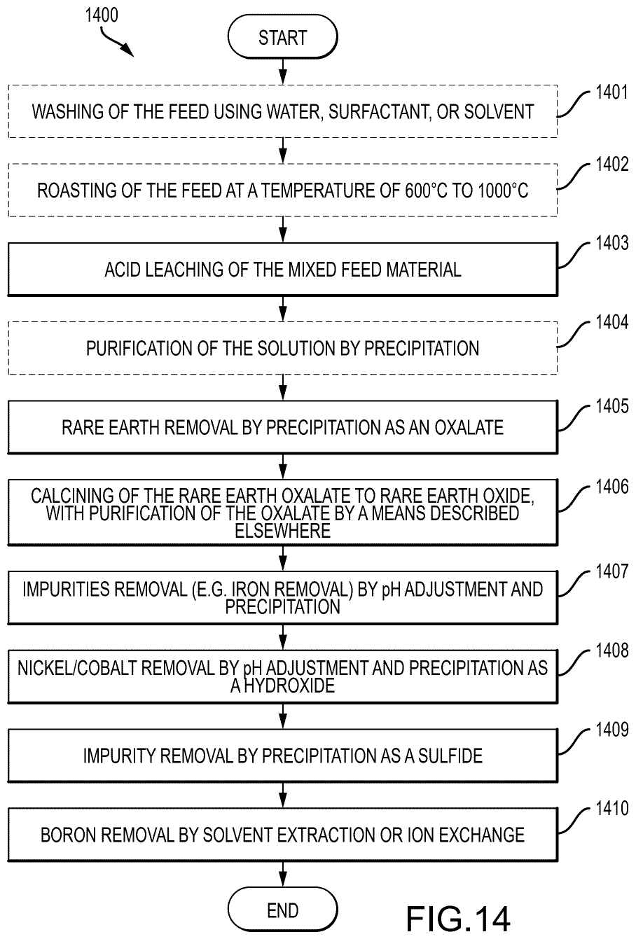

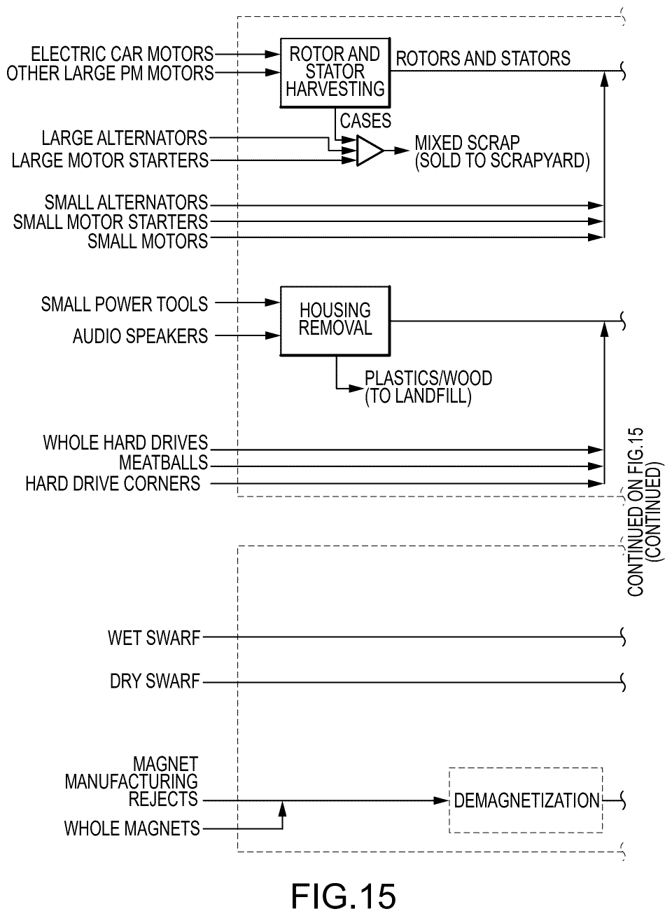

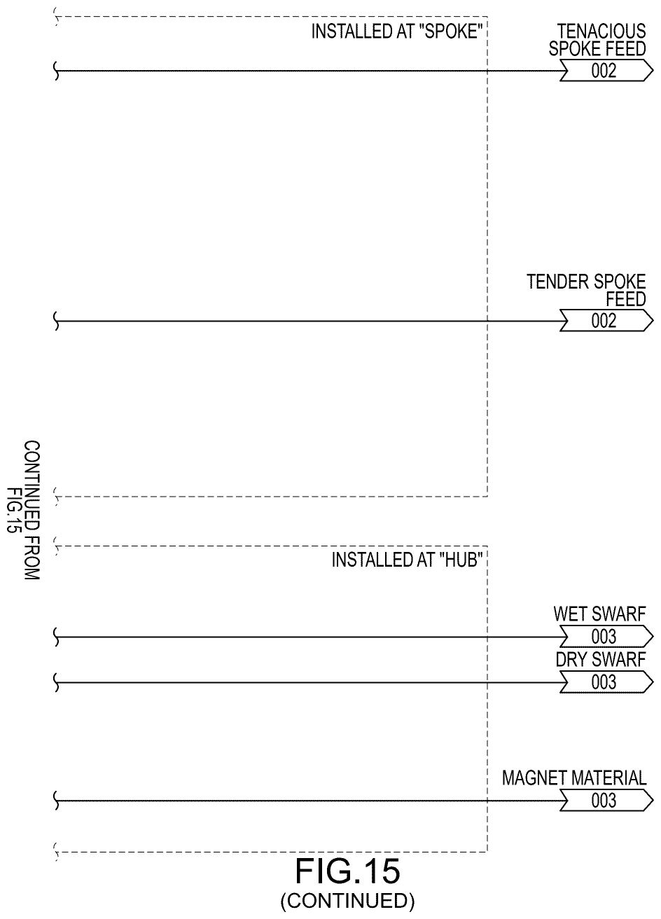

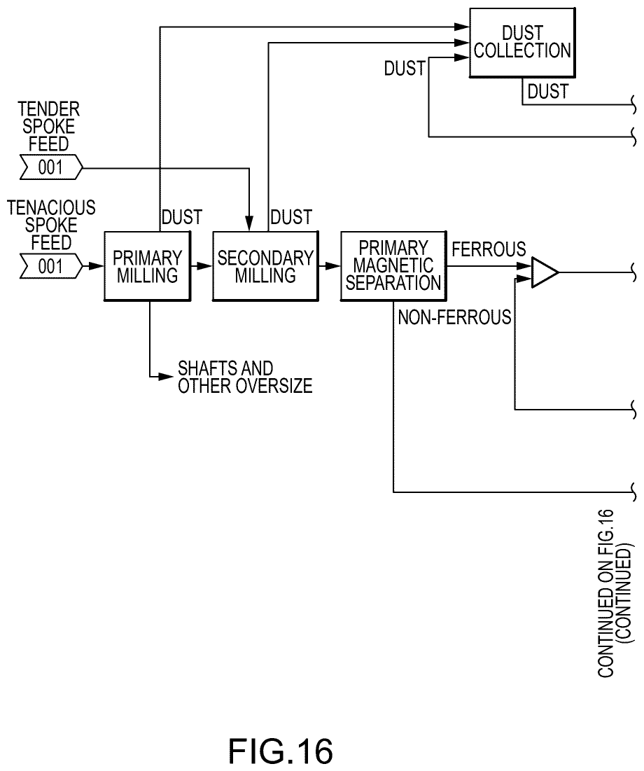

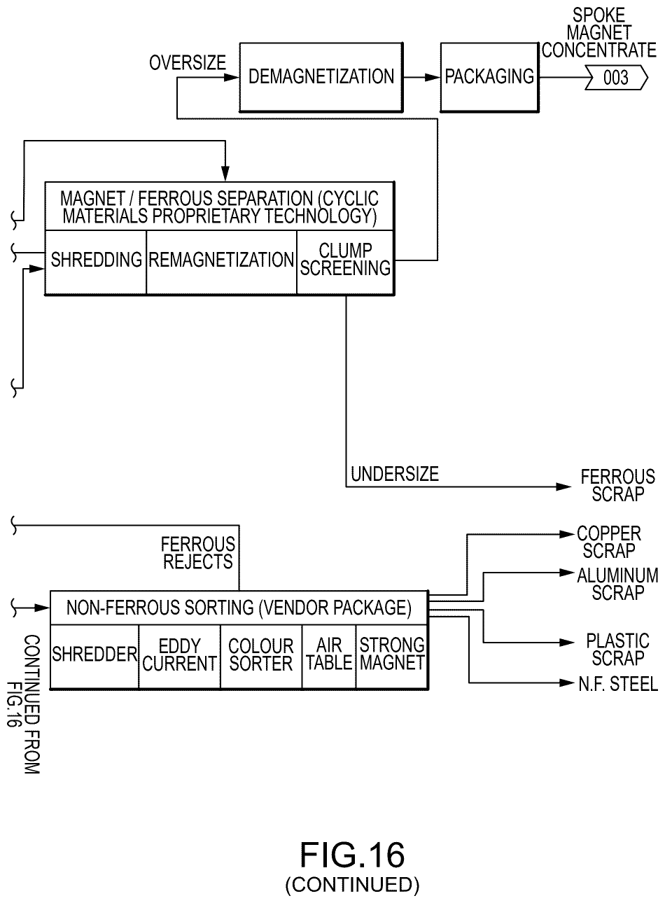

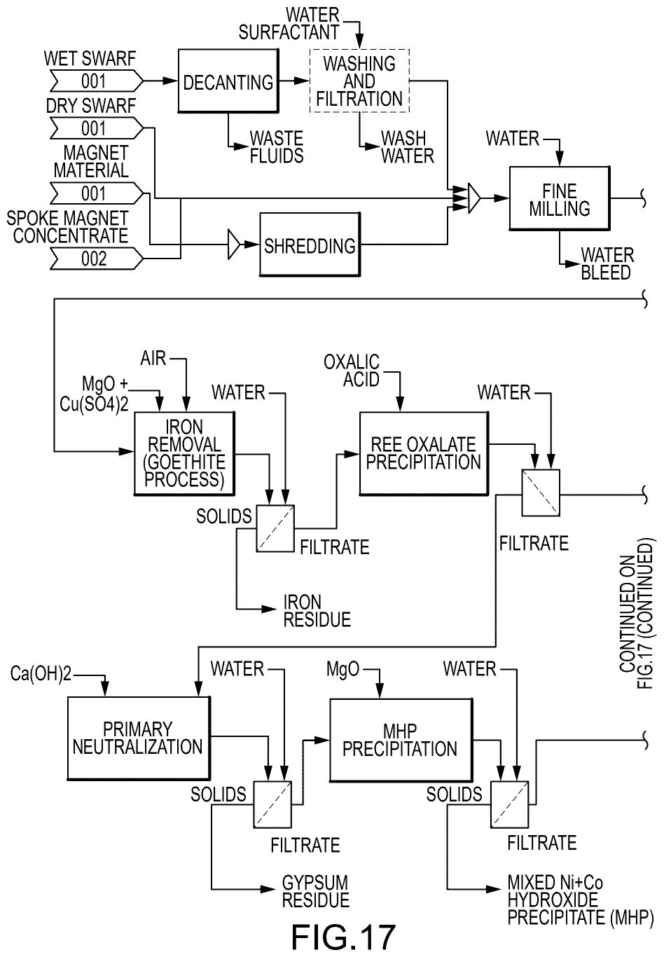

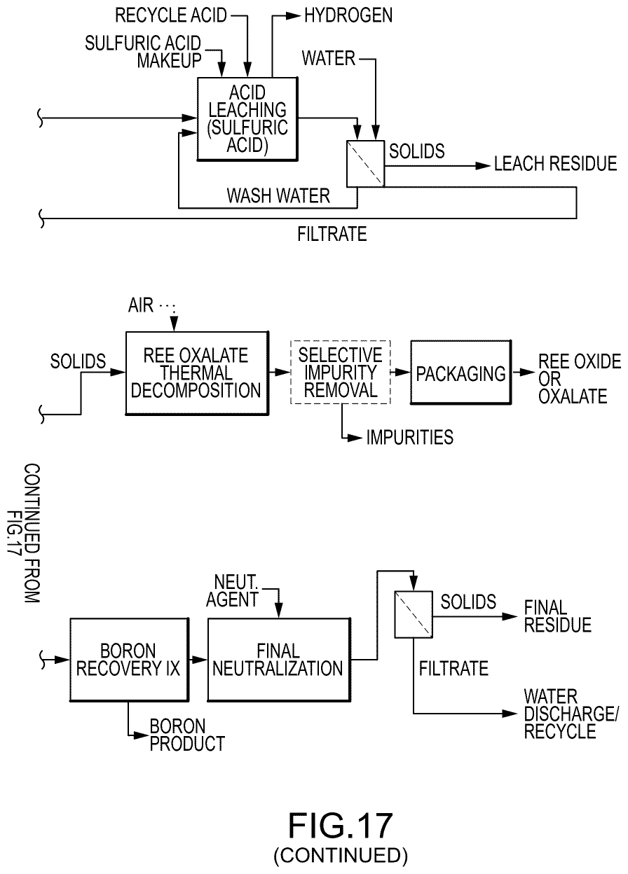

A variation of process 1300 is shown as process 1400 depicted in FIG. 14 containing additional steps not present in FIG. 13.

Step 1401 involves washing of the feed using water, surfactant, or solvent

Step 1402 involves roasting of the feed at a temperature of 600°° C. to 1000° C.

Step 1403 involves acid leaching of the mixed feed material.

Step 1404 involves purification of the solution by precipitation.

Step 1405 involves Rare earth removal by precipitation as an oxalate.

Step 1406 involves Calcining of the rare earth oxalate to rare earth oxide, with purification of the oxalate by a means described elsewhere.

Step 1407 involves impurities removal (e.g. iron removal) by pH adjustment and precipitation.

Step 1408 involves nickel/cobalt removal by pH adjustment and precipitation as a hydroxide.

Step 1409 involves impurity removal by precipitation as a sulfide.

Step 1410 involves Boron removal by solvent extraction or ion exchange.

The process 1400 then terminates.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1.-42. (canceled)

43. A method comprising:
a) obtaining a feed material comprising scrap that contains proportion of magnets, the feed material comprising ferromagnetic material and non-ferromagnetic material;
b) reducing the size of the feed material to form a reduced size feed material;
c) separating the reduced size feed material into the ferromagnetic material and the non-ferromagnetic material; and
d) separating the ferromagnetic material into a magnet-enriched target magnetic material concentrate and a non-target magnetic material-depleted scrap.

44. The method of claim 43, wherein the feed material contains a rare earth element and one or more of: neodymium magnets, samarium cobalt magnets, and cobalt and/or nickel containing magnets.

45. The method of claim 43, wherein the reducing (b) comprises use of one or more milling processes.

46. The method of claim 43, wherein the separating (c) comprises use of one or more of a revolving drum, steel idler, demagnetizer, magnetizer, heating furnace, eddy current separators, shaker tables, air tables, optical sorters, and gravity sorters,
wherein the non-ferromagnetic material comprises aluminum, copper, plastics, non-ferromagnetic metals, and combinations thereof, and
wherein the ferromagnetic material comprises steel, magnets, and combinations thereof.

47. The method of claim 43, wherein the feed material comprises feed material of differing sizes, wherein the reducing (b) comprises:
comminuting the feed material to a pre-determined size to form the reduced size feed material, wherein the reduced size feed material is formed as a result of the comminuting.

48. The method of claim 43, wherein the magnets in the reduced size feed material has a degree of magnetization that is less than a degree of magnetization of the magnets in the feed material and wherein the separating (c) comprises:
passing the reduced size feed material through a re-magnetizing circuit to form re-magnetized feed material;
separating, by a ferromagnetic surface, the reduced size feed material into a magnetic portion and a non-magnetic portion, the ferromagnetic surface comprising one of a ferromagnetic iron drum, ferromagnetic conveyor belt idler, and ferromagnetic collection band; and
passing the magnetic material over a set of N screens to produce N+1 product fractions, the fractions comprising oversize fraction containing a first set of magnet clumps and fine dust fraction, the magnet-enriched target magnetic material concentrate comprising the first set of magnet clumps.

49. The method of claim 48, wherein the separating (d) comprises:
capturing dust generated by the comminuting in a dust collector;
combining the fine dust fraction with the dust from the dust collector to form a dust stream;
passing the dust stream through a circuit containing re-magnetizing-clumping-screening to output fine particles comprising a second set of magnet clumps;
short grinding of the first and second sets of magnet clumps to form short ground magnet clumps;
screening the short ground magnet clumps to capture the magnetic material in an undersized fraction of the screening as a portion of the magnet-enriched target magnetic material concentrate; and
optionally recycling the oversized fraction of the screen to the short grinding.

50. The method of claim 43, wherein the separating (d) comprises:
passing the ferromagnetic material through one or more of a size reduction apparatus, a rotating drum, a remagnetization device, and a combination thereof,
wherein the magnet-enriched target magnetic material concentrate comprises rare earth element(s) containing magnets,
wherein the non-target magnetic material-depleted scrap comprises a ferromagnetic iron alloy, and
wherein the non-ferromagnetic material comprises plastic, aluminum, copper, non-metallics, and combinations thereof.

51. The method of claim 43, further comprising:
acid leaching the magnet-enriched target magnetic material concentrate to form a pregnant leach solution comprising one or more rare earth elements;
removing at least most of any iron from the pregnant leach solution by pH, oxidative reductive potential, and/or temperature adjustment followed by iron precipitation to form an iron purified solution;
removing the one or more rare earths from the iron purified solution by precipitation of the one or more rare earths as a precipitate comprising an oxalate, carbonate, and/or other rare earth salt to form a barren leach solution;
calcining the rare earth precipitate to form a calcined product comprising at least most of the one or more rare earths as a rare earth oxide.

52. The method of claim 51, further comprising:
removing at least most of any nickel and cobalt from the barren leach solution by solvent extraction and/or precipitation by pH adjustment of the nickel or cobalt as an oxide or hydroxide.

53. The method of claim 51, further comprising:
removing at least most of any copper or zinc from the barren leach solution solvent extraction and/or precipitation.

54. The method of claim 51, further comprising:
removing at least most of any boron in the barren leach solution by solvent extraction, pH adjustment, precipitation, and/or ion exchange.

55. The method of claim 52, further comprising:
receiving one or more of swarf, defective magnets and currently unusable magnets;
washing the one or more of swarf, defective magnets and currently unusable magnets using water, surfactants, or solvent; and
reducing the size of the washed one or more swarf, defective magnets and currently unusable magnets;
wherein the reduced size swarf, defective magnets and currently unusable magnets are input to the acid leaching step.

56. The method of claim 43, wherein the feed material comprises one or more of motors, hard disk drives, speakers, compressors, meatballs, alternators, motor starters, power tools, hard drive corners, magnet manufacturing rejects, and other electromechanical devices containing magnets.

57. A system configured to perform the steps of claim 43.

58. A method, comprising:
(a) receiving a magnet-enriched target magnetic material concentrate comprising magnets comprising rare-earth containing magnets, cobalt-containing magnets other than samarium cobalt magnets, and nickel-containing magnets, and combinations thereof;
(b) acid leaching the magnet-enriched target magnetic material concentrate to form a pregnant leach solution comprising iron, rare earth elements, and one or more of cobalt and nickel;
(c) precipitating at least a portion of the iron from the pregnant leach solution to form an iron-depleted solution comprising the rare earth elements and the one or more of cobalt and nickel and an iron-containing precipitate;
(d) removing at least a portion of the rare earth elements from the iron-depleted solution to form a rare earth product; and
(e) removing at least a portion of the one or more of cobalt and nickel from the iron-depleted solution to form a metal product comprising one or more of cobalt and nickel.

59. The method of claim 57, further comprising one or more of the following:
milling, after step (a) and prior to step (b), the magnet-enriched target magnetic material concentrate to a milled material of a pre-determined size range;
removing at least most of any boron from the iron-depleted solution by solvent extraction, precipitation, and/or ion exchange
removing at least most of any copper or zinc from the iron-depleted solution by solvent extraction, precipitation, and/or ion exchange.

60. The method of claim 58, wherein the removing (d) comprises:
selectively precipitating the rare earth elements as rare earth oxalates or carbonates to form the rare earth product.

61. The method of claim 58, wherein in the removing (d), a portion of any remaining iron, rare earth elements, and one or more of cobalt and nickel are precipitated as one of a high purity oxalate, high purity carbonate, and mixed oxalate and carbonate.

62. The method of claim 61, wherein the removing (d) comprises:
selectively calcining the one of a high purity oxalate, high purity carbonate, and mixed oxalate and carbonate at a temperature between about 150 to about 1,200° C. to calcine at least a portion of the iron and one or more of cobalt and nickel without calcining at least a portion of the rare earth elements; and
forming the rare earth product comprising one or more of neodymium and samarium and a metal product comprising one or more of cobalt and nickel from the calcined at least a portion of the iron and one or more of cobalt and nickel.

63. The method of claim 58, further comprising:
(i) obtaining a feed material derived from one or more of magnets and magnetic scrap from magnet production, the feed material comprising ferromagnetic material and non-ferromagnetic material;
(ii) reducing the size of the feed material to form a reduced sized feed material having a lower level of magnetization than the magnet material in the feed;
(iii) separating the reduced size feed material into the ferromagnetic material and the non-ferromagnetic material; and
(iiii) separating the ferromagnetic material into the magnet-enriched target magnetic material concentrate and a non-target magnetic material-depleted scrap, wherein the magnet-enriched target magnetic material concentrate is input to the receiving (a).

64. The method of claim 63, wherein the separating (iii) comprises:
passing the de-magnetized feed material through a re-magnetizing circuit to form re-magnetized feed material;
passing the re-magnetized feed material over a set of N screens to produce N+1 product fractions, the fractions comprising oversize fraction containing a first set of magnet clumps and fine dust fraction, the magnet-enriched target magnetic material concentrate comprising the first set of magnet clumps;
comminuting the first set of magnet clumps to form a comminuted first set of magnet clumps;
screening the comminuted first set of magnet clumps to capture the magnetic material in an undersized fraction of the screening as a portion of the magnet-enriched target magnetic material concentrate.

65. The method of claim 63, wherein the separating (iii) comprises:
passing the ferromagnetic material through one or more of a size reduction apparatus, a rotating drum, a re-magnetization device, or a combination thereof,
wherein the magnet-enriched target magnetic material concentrate comprises rare earth element(s) containing magnets,
wherein the non-target magnetic material-depleted scrap comprises steel, and
wherein the non-ferromagnetic material comprises plastic, aluminum, copper, non-metallics, and combinations thereof.

66. The method of claim 58, wherein the rare earth elements comprises one or more of neodymium and samarium, and wherein the rare earth product comprises one or more of neodymium and samarium.

67. A system configured to perform the steps of claim 58.
